(19) United States
(12) Patent Application Publication
(10) Pub. No.: US 2021/0020000 A1
(43) Pub. Date: Jan. 21, 2021

(54) Electronic Gaming Machine and Gaming Method

(71) Applicant: Ainsworth Game Technology Limited, Newington (AU)

(72) Inventor: Jason Meyer, Abbotsford (AU)

(21) Appl. No.: 17/062,152

(22) Filed: Oct. 2, 2020

Related U.S. Application Data
(63) Continuation of application No. 16/053,334, filed on Aug. 2, 2018.
Application No. 16/053,334 is a continuation of application No. 14/252,739, filed on Apr. 14, 2014, now abandoned.

(30) Foreign Application Priority Data
Apr. 15, 2013 (AU) 2013901298

(51) Int. Cl. G07F 17/34; G07F 17/32

(52) U.S. Cl. CPC G07F 17/34; G07F 17/3267

(57) ABSTRACT

The invention provides an electronic gaming machine comprising an electronic game controller and a display. A game is shown on the display, comprising game symbols displayed in predetermined game positions on said display and where predetermined winning combinations of randomly selected game symbols in the game award prizes to a player. The appearance of at least one special symbol in a play of the game causes the display of an additional special symbol for one or more subsequent plays of the game. A corresponding method is also provided.

This application is a continuation of U.S. patent application Ser. No. 16/053,334, filed Aug. 2, 2018, which is a continuation of U.S. patent application Ser. No. 14/252,739, filed Apr. 14, 2014, which claims priority from Australian patent Application No. 2013901298, filed Apr. 15, 2013, all of which applications are incorporated by reference herein.

### BACKGROUND

The present invention relates to an electronic gaming machine and in particular an electronic gaming machine using a base game and a feature game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played. Conventionally, such reel-type games comprise a main or base game offered by the electronic gaming machine.

Bonus or “feature” games may be provided by an electronic gaming machine in addition to the base or main game. Typically feature games use the same set of reels as the main game and are limited to a set of free games operated under a single set of rules that may be slightly modified from the base game. Once the free feature games have been played, the electronic gaming machine resets itself and returns the player back to the base game. This standard structure to game play limits the variation in the play of the electronic gaming machine. Consequently, it is difficult to retain player interest because there is no apparent incentive for the player to continue playing the same electronic gaming machine. Also, it is difficult to retain player interest since there is little differentiation between gaming machines in terms of the main and feature games that are played.

It is an object of the present invention to overcome or substantially ameliorate one or more of the disadvantages of prior art, or at least to provide a useful alternative.

It is an object of the invention in at least one preferred form to provide an electronic gaming machine and a method for controlling an electronic gaming machine that encourages player interest.

### SUMMARY

According to a first aspect of the invention, there is provided an electronic gaming machine comprising:

a display for displaying a game, wherein said game comprises game symbols displayed in predetermined game positions on said display and where predetermined winning combinations of randomly selected game symbols in said game award prizes to a player, said game symbols including one or more special symbols, and

an electronic game controller for controlling the display of game symbols on said display,

wherein the appearance of at least one special symbol in a play of said game causes said electronic game controller to display an additional special symbol in addition to said at least one special symbol on said display for one or more subsequent plays of said game.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Preferably, said electronic game controller causes the display of at least one additional special symbol in addition to the special symbols displayed on said display from a preceding play of said game.

Preferably, the number of special symbols on said display successively increases for each of said subsequent plays of said game. More preferably, said number of special symbols increases by one for each said subsequent play.

Preferably, the number of special symbols does not decrease between consecutive subsequent plays of said game.

Preferably, said electronic game controller selects the predetermined game positions to display said additional special symbols according to a predetermined order. More preferably, said predetermined order comprises a sequence of predetermined game positions.

Alternatively, it is preferred that said electronic game controller randomly selects the predetermined game positions to display said additional special symbols.

Preferably, said electronic game controller causes each special symbol previously displayed in a preceding play to be displayed in the same predetermined game position for at least one subsequent play.

Preferably, said electronic game controller randomly selects the predetermined game position of each additional special symbol to be displayed in each said subsequent play and randomly reselects the predetermined game position of each special symbol previously displayed in a preceding play.

Preferably, said electronic game controller selects the predetermined game position of each said additional special symbol before the start of each of said subsequent plays.

Preferably, each said additional special symbol occupies a unique predetermined game position on said display.

Preferably, said game comprises a base game and a feature game, said play comprising a play of said base game and said subsequent plays comprising plays of said feature game. Alternatively, said game comprises a feature game, said play and said subsequent plays comprising plays of said feature game. In a further alternative, said game comprises a base game and a feature game, said at least one special symbol appearing in said feature game in response to a trigger event occurring in said base game, and wherein said play and said subsequent plays comprise plays of said feature game.

Preferably, said at least one special symbol appears in response to a trigger event.

Preferably, said predetermined game positions are arranged in an array on said display. In one preferred form, said shape is rectangular. However, it will be appreciated that other shapes can be formed, including square, triangular or other polygonal shapes, as well as irregular shapes such as a shape having uneven rows and/or columns.

In one preferred form, there is a plurality of said arrays on said display, and in this case the appearance of said at least one special symbol on a first array causes the display of said additional special symbols for said subsequent plays of the game on said first array. In other words, the effect of the at least one special symbol appearing is limited to the array on which it appears. Alternatively, the appearance of said at least one special symbol on a first array causes the display of said additional special symbols for said subsequent plays of each game on some or all of said arrays.

Preferably, said special symbol comprises at least one of said game symbols, a substitute symbol, a symbol that reveals another game symbol and a new game symbol.

Preferably, as part of said game, said columns visually move to simulate rotation thereof and said play comprises from when said columns begin to visually move to when said columns stop visually moving. Alternatively, said predetermined game positions individually move visually to simulate rotation of each said predetermined game position.

Preferably, said game comprises a jackpot prize. More preferably, said jackpot prize comprises a mystery jackpot. In one preferred form, said game shares said jackpot prize with another game played on said electronic gaming machine. In another preferred form, said game shares said jackpot prize with another game played on a different electronic gaming machine to said electronic gaming machine.

Preferably, the game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to said trigger event. Alternatively, said electronic game controller causes the display of said feature game and said base game during play of said base game, said feature game being inactive until triggered. In this preferred form, the change in said feature game from being inactive to active may be indicated on the display.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

According to a second aspect of the invention, there is provided a gaming method for an electronic gaming machine comprising a display and an electronic game controller, the method comprising the steps of:

controllably displaying game symbols in predetermined game positions on said display for playing a game, wherein said game symbols comprise one of more special symbols, and where predetermined winning combinations of randomly selected game symbols award prizes to a player, and

in response to the appearance of at least one special symbol in a play of said game, displaying an additional special symbol in addition to said at least one special symbol on said display for one or more subsequent plays of said game.

Preferably, said additional special symbol displaying step comprises displaying at least one additional special symbol in addition to the special symbols displayed on said display from a preceding play of said game

Preferably, said method further comprises successively increasing the number of special symbols on said display for each of said subsequent plays.

Preferably, said additional special symbol displaying step comprises ensuring the number of special symbols does not decrease between consecutive subsequent plays of said game.

Preferably, said method further comprises selecting the predetermined game positions to display said additional special symbols according to a predetermined order. More preferably, said predetermined order comprises a sequence of predetermined game positions.

Preferably, said method further comprises randomly selecting the predetermined game positions to display said additional special symbols.

Preferably, said method further comprises displaying each special symbol previously displayed in a preceding play the same predetermined game position for at least one subsequent play.

Preferably, said method further comprises randomly selecting the predetermined game position of each additional special symbol to be displayed in each said subsequent play and randomly reselecting the predetermined game position of each special symbol previously displayed in a preceding play.

Preferably, said method further comprises selecting the predetermined game position of each said additional special symbol before the start of each of said subsequent plays.

Preferably, said method further comprises providing each said additional special symbol to be displayed in a unique predetermined game position on said display.

Preferably, said game comprises a base game and a feature game, said play comprising a play of said base game and said subsequent plays comprising plays of said feature game. Alternatively, said game comprises a feature game, said play and said subsequent plays comprising plays of said feature game. In a further alternative, said game comprises a base game and a feature game, said method further comprising causing a trigger event in said base game and triggering said appearance of said at least one special symbol in said feature game in response to said trigger event, wherein said play and said subsequent plays comprise plays of said feature game.

Preferably, said method further comprises triggering said appearance of said at least one special symbol in response to a trigger event

Preferably, said method further comprises the step of visually moving said columns as part of said game to simulate rotation of said columns and wherein said play comprises from when said columns begin to visually move to when said columns stop visually moving.

Preferably, the method further comprises the step of providing a jackpot prize for said game. More preferably, said jackpot prize comprises a mystery jackpot. In one preferred form, said method comprises the steps of more than one game on said electronic gaming machine and sharing said jackpot prize between at least two of said games. In another preferred form, said method comprises the steps of sharing said jackpot prize between said game and a game playable on another electronic gaming machine.

The method also preferably has the preferred features of the first aspect of the invention not otherwise stated above.

According to a third aspect of the invention, there is provided a computer system comprising a central processing unit configured for communication with an electronic gaming machine, wherein said computer system is configured to perform the method of the second aspect of the invention.

According to a fourth aspect of the invention, there is provided a computer programme configured to perform the method of the second aspect of the invention.

According to a fifth aspect of the invention, there is provided a non-transitory carrier medium carrying computer executable code that, when executed on a central processing unit configured for communication with an electronic gaming machine, causes the central processing unit to perform the method of the second aspect of the invention.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1;

FIG. 3 is a schematic drawing illustrating a game displayed on the electronic gaming machine of FIG. 1, and

FIGS. 4 to 7 are schematic drawings illustrating subsequent plays of the game of FIG. 3.

### PREFERRED EMBODIMENTS OF THE INVENTION

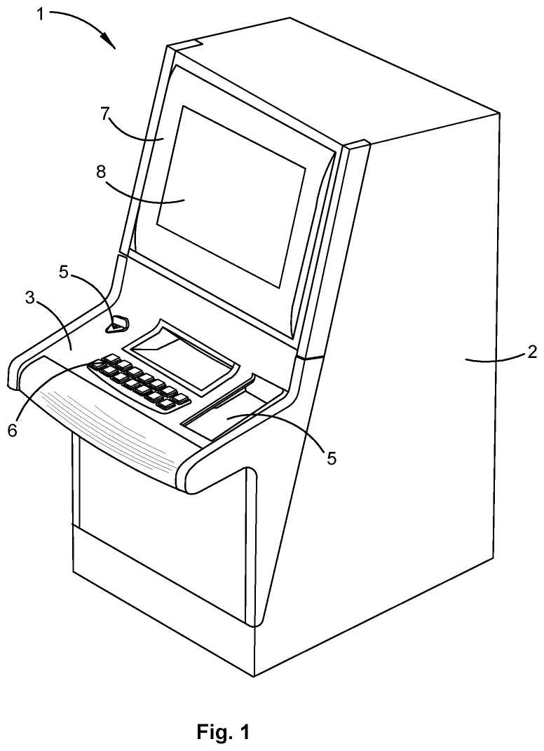

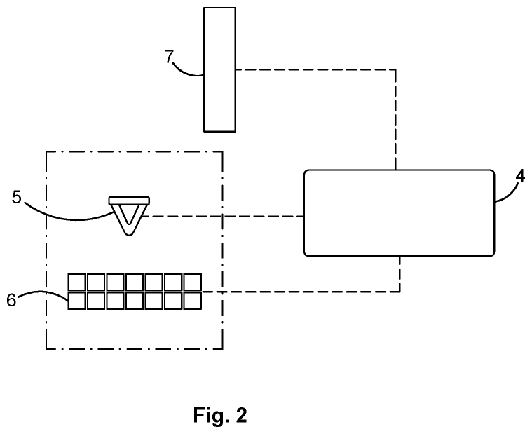

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. The electronic game controller 4 is generally in the form of a central processing unit, such as a computer, and is in electronic communication with a display in the form of a video display screen 7, as well as various input devices on the console 3, as best shown in FIG. 2. It is also appreciated that a person skilled in the art would readily understand the location and use of the electronic game controller 4 in the electronic gaming machine 1.

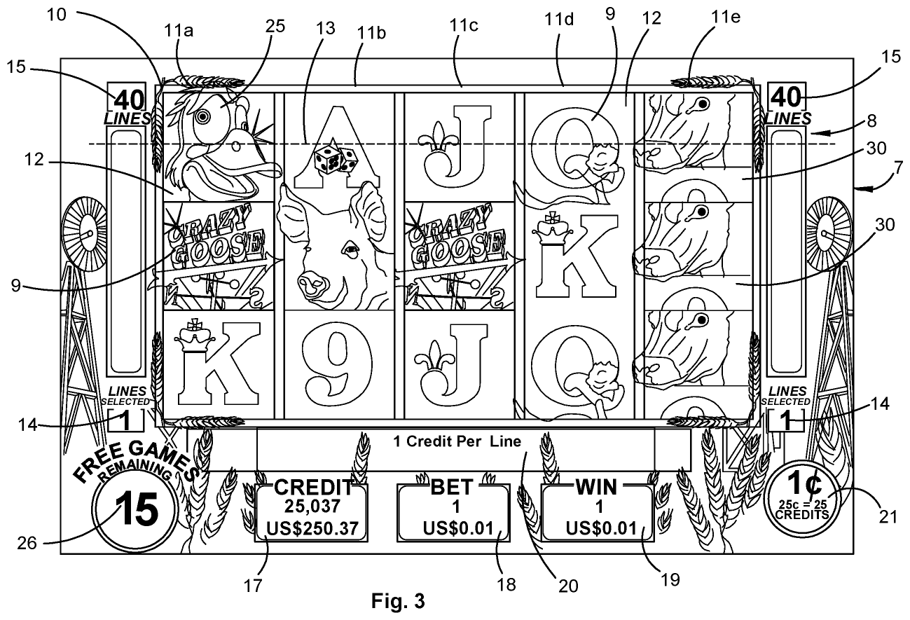

The electronic game controller 4 is programmed to provide a game in the form of a base game (not shown) and a feature game 8 on the electronic gaming machine 1 for play by a player, as best shown in FIG. 1. The feature game 8 has game symbols 9 arranged into an array 10 in the form of five columns or “reels” 11, as best shown in FIG. 3. While the array 10 is arranged with five columns or “reels” 11 and an even number of rows, it will be appreciated by one skilled in the art that other arrays could be used, such as the industry standard 5×3 or 3×3, 4×3, 5×5, 4×4, etc. Also, the array 10 can have an uneven number of rows and/or columns.

The array 10 of the feature game 8 defines predetermined game positions in the form of “squares” or cells 12, in which the game symbols 9 appear. The array 10 is arranged so that a player can select one or more predetermined “pay lines” 13 defined around the array, which correspond to combinations of the game positions 12. The pay lines 13 correspond to the lines selected by the player and generally comprise at least one game position 12 from each reel 11. The number of pay lines 13 that can be selected by the player depends on the amount of the monetary bet for playing a game on the array 10. In the feature game, predetermined winning combinations of randomly selected game symbols 9 result in the award of prizes to the player, usually of an enhanced value compared to the prizes awarded in the base game.

The game symbols 9 can include a mixture of picture symbols (such as animal symbols, playing card symbols, scatter symbols, wild card symbols) and trigger symbols to trigger a feature game (if any). The electronic game controller 4 randomly determines the appearance of the game symbols 9 on the array 10.

The video screen 7 may also display other standard game information including the number of player-selected pay lines 14, the number of pay lines available 15, the amount of credits per line 17, the amount of player credits the amount of the current bet wagered by the player 18, the amount of wins by the player 19, a message area 20 and a current denomination button 21 indicating the currently selected base bet denomination.

The player initially makes a bet using vending slots 5 initiate play of the electronic gaming machine 1 to build up credit to play the base game on the electronic gaming machine. For example, the player can bet or wager monetary amounts equivalent to a particular amount of credits, depending on the bet denomination selected for the base game. Also, the player can make any additional side bets or ante-bets during play of the base game once the game has commenced to access additional features in the game, such as increasing the number of winning combinations in the game. In this embodiment, the base game has the same game symbols 9, array 10, reels 11, cells 12 and player-selectable pay lines 13 as the feature game 8.

The electronic game controller 4 then causes the reels 11 to appear to visibly rotate or “spin”, and randomly display the game symbols 9 in each cell 12 for each play of the game. In this embodiment, the electronic gaming machine offers a base or main game and a feature game. A trigger event in the base game, such as the appearance of a predetermined number of trigger symbols or scatter symbols (usually three), causes the display screen 7 to display the feature game. In this feature game, fifteen free plays or spins of the feature game are awarded to the player without having to make an additional bet or wager. Typically, these free plays are commonly referred to as “free games”. The feature game operates in a similar manner to the base game and uses the same array 10 of reels 11, where the reels visibly rotate and randomly display game symbols in each cell 12, as best shown in FIG. 3.

The electronic game controller 4 also randomly determines whether a special symbol in the form of a “goose head” symbol 25 will appear one of the predetermined positions 12 on the display 7, also shown in FIG. 3. The goose head symbol 25 in this embodiment acts as a symbol that reveals another game symbol 9 (including a substitute, scatter, jackpot or trigger symbol) at the end of the play or spin. This “mystery” element to the goose head symbol 25 enhances the player's anticipation during game play and thus increases his or her interest and excitement in the game played on the electronic gaming machine 1.

After the reels 11 stop spinning, the electronic game controller 4 determines whether there are any goose head symbols 25 on the array 10. If not, then the electronic game controller 4 determines whether there are any predetermined winning combinations of the game symbols 9 appearing in any player-selected pay lines 13, such as “three of a kind”, “four of a kind” and “five of a kind” and/or other combinations of a “full house”, “straight” or “flush” where the game symbols represent playing cards. It will be appreciated that other winning combinations of game symbols 9 can also be provided. If so, the electronic game gaming machine 1 enters a winning game state and awards a prize according to the displayed predetermined winning combination(s). The display screen 7 also displays the number of free games or spins left in the feature game in a counter 26.

Where one or more goose head symbols 25 appear on the array 10, the electronic game controller determines whether any predetermined winning combinations of the game symbols 9 appear in any player-selected pay lines 13 as a result of the goose head symbols 25 revealing another game symbol. If so, the electronic game gaming machine 1 enters a winning game state and awards a prize according to the displayed predetermined winning combination(s).

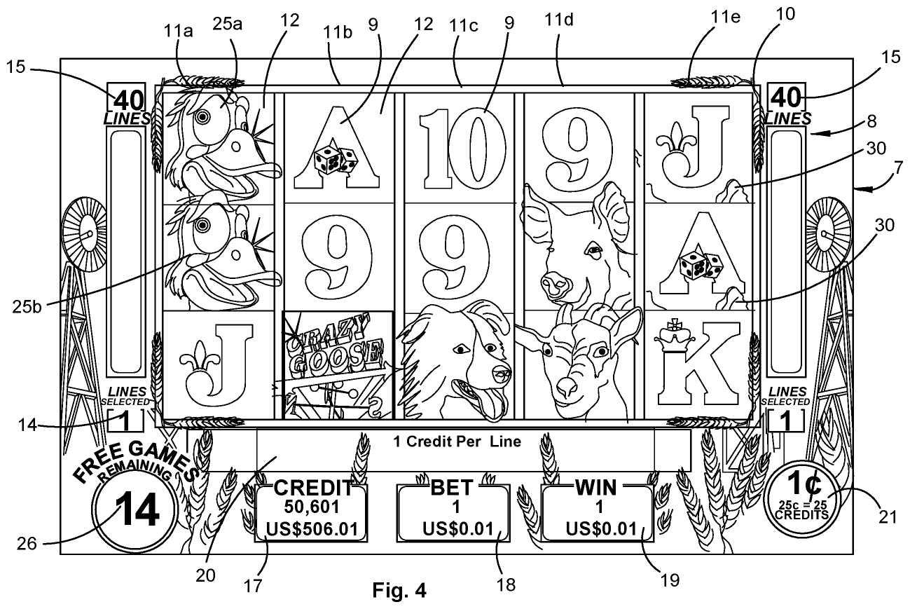

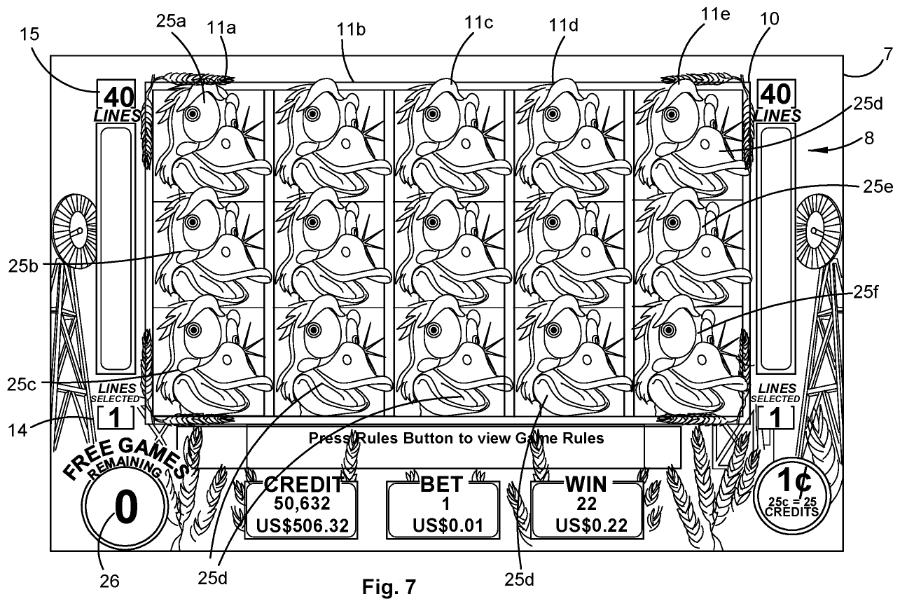

The appearance of the goose head symbol 25a in the play or spin of the feature game in FIG. 3 also causes the electronic game controller 4 to display an additional goose head symbol 25b for the next or subsequent play or spin of the game, as best shown in FIG. 4 where corresponding features have been given the same reference numerals. The electronic game controller 4 may select the predetermined position or cell 12 for the additional goose head symbol 25b randomly from the available cells 12 in the array 10. Alternatively, the electronic game controller 4 may select the predetermined position or cell 12 for the additional goose head symbol 25b according to a predetermined order, which would comprise a specific sequence of cells 12 from the array 10. This successive addition of goose head symbols 25 occurs for each successive play of the game until the feature game ends when all fifteen free games or plays of the feature game are finished; as indicated by the counter 26 in FIG. 7.

In the preferred embodiment, the electronic game controller 4 selects the cells 12 for the additional goose head symbol 25 according to a predetermined order of cells in the array. This includes the initial goose head symbol 25a, as once the electronic game controller 4 randomly determines that the initial goose head symbol 25a should appear on the array 10, it then causes the goose head symbol 25a to be displayed in the top cell 12 of the leftmost reel 11a in the array.

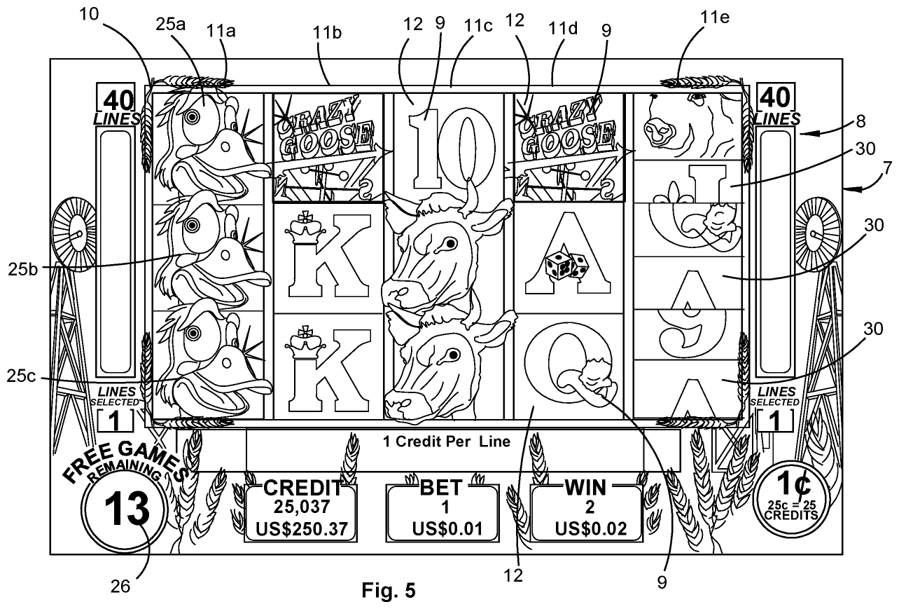

In the next or successive play; as best shown in FIG. 4, the additional goose head symbol 25b appears in the middle cell 12 of the reel 11a. The display of the additional goose head symbol 25b in turn causes the electronic game controller 4 to cause the display of another goose head symbol 25c for the next play of the feature game; as best shown in FIG. 5 where corresponding features have been given the same reference numerals. Again, the display of the additional goose head symbol 25c causes the electronic game controller 4 to display another goose head symbol 25d in the top cell 12 of the adjoining reel 11b. The additional goose head symbols 25d in the following spins or plays of the feature game are added to the array 10 so as to successively occupy the top, middle and then bottom cell 12 of reel 11b, and this sequence is repeated from reels 11c, 11d and 11e. Thus, the number of goose heads symbols 25 gradually increase with each successive spin or play of the feature game.

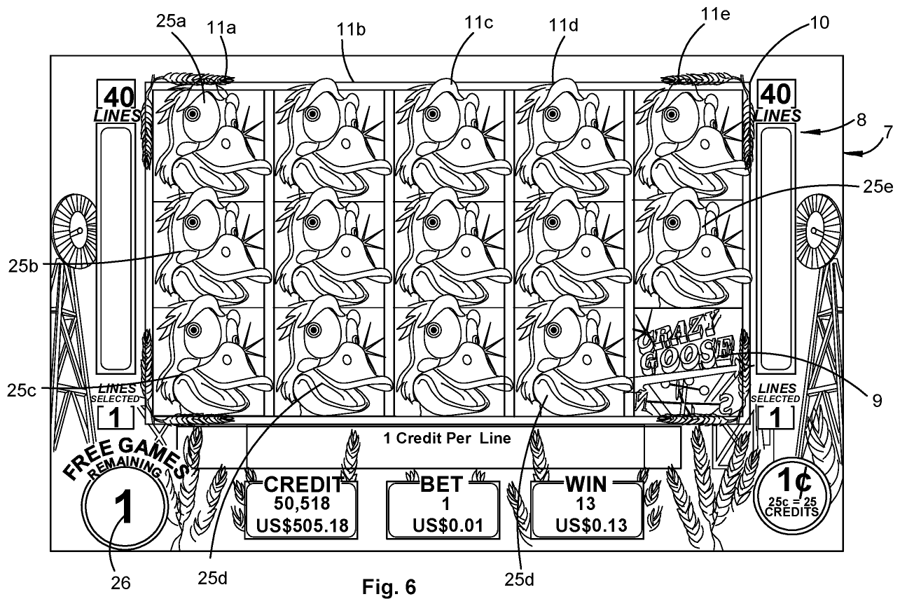

The fourteenth or the second last spin or play of the feature game is illustrated in FIG. 6, where corresponding features have been given the same reference numerals. In this play of the feature game, each of the preceding plays have resulted in the cells 12 of the reels 11a, 11b, 11c and 11d being filled by goose head symbols 25a, 25b, 25c and 25d. In this spin, the additional goose head symbol 25e is displayed in the middle cell 12 of the reel 11e.

The fifteenth or last spin or play of the feature game is illustrated in FIG. 7, where corresponding features have been given the same reference numerals. In this spin, the additional goose head symbol 25f is displayed in the bottom cell 12 of the reel 11e. Thus, at the conclusion of this last play, the goose head symbols 25a, 25b, 25c, 25d, 25e and 25e will all reveal the same game symbol 9, thus resulting in a predetermined winning combination that awards a large prize to the player.

For each spin or play of the feature game, the electronic game controller 4 determines the appearance of predetermined winning combinations of game symbols 9 on player-selected pay lines 13 due to the symbols revealed by the goose head symbols 25. Thus, not only is there an increased probability of winning a prize for each successive play or spin, there is also an increased probability of any awarded prize being larger for each successive play.

In addition, in the embodiment the electronic game controller 4 selects the cells 12 of each additional goose head symbol 25 before the start or commencement of the spin or play of the feature game. Furthermore, the additional goose head symbols 25 are displayed sequentially on a reel by reel basis so that the symbols are gradually displayed on the array 10. This is best shown in FIGS. 3 and 5, where the reel 11e has not finished spinning as indicated by the cells 12 showing portions 30 of the game symbols 9. Also, the goose head symbols 25 appear in unique cells 12 in the array 10 and do not appear in addition to the cells 12 or share a cell with another game symbol 9 or special symbol 25.

Also, the special symbols 25 are displayed in the same cell 12 for each subsequent play of the feature game 8. This provides the player certainty that any special symbols 25 which appear are retained in their displayed position for the duration of the feature game 8. In other embodiments, the special symbols 25 are displayed in the same cell 12 for one or some subsequent plays, and then move to a different cell or cells for the remaining subsequent plays, to create variety in game play.

It thus can be seen that as more special symbols 25 appear on the array 10, this increases the probability of a predetermined winning combination of game symbols 9 appearing on the array 10 in each successive play of the feature game, and thus increasing the probability of both a prize being awarded to the player and the size of the award. Consequently, once the player sees the first goose head symbol 25a appear on the array, his or her anticipation is heightened as he or she will recognise that successive plays of the feature game will keep adding goose head symbols until the feature game ends. Also, the player is assured that the number of special symbols does not decrease between consecutive successive plays, but continually increase in number. Thus, there is no risk of building a substantial number of special symbols 25 on the array 10 that are partly or fully lost in the next play that resets or reduces the number of special symbols. Where the first goose head symbol 25a appears on the first play of the feature game, the player will know that the array 10 will be filled with the same symbol at the end of the feature game, resulting in a large win. All these factors increase the player's excitement and interest in the game played on the electronic gaming machine 1.

While the goose head symbols 25 act as a reveal symbol in the preferred embodiment, it will be appreciated that the special symbol 25 can act as a substitute (wild card) symbol, scatter symbol, jackpot symbol, trigger symbol or any other game symbol 9. The goose head symbols 25 could also change into a completely new symbol different to the other game symbols, the new symbol conferring a game enhancing element such as a bonus prize or free games.

The electronic game controller 4 randomly determines the appearance of the trigger symbols in the base game that activate the feature game 8. However, it will be appreciated that this determination need not be totally random as the electronic game controller 4 may switch to a reel strip having a greater probability of a trigger symbol appearing where the feature game has not be triggered for a predetermined number of plays of the base game.

In other preferred forms, for each successive play the electronic game controller randomly selects the predetermined game position of each additional special symbol to be displayed in each said subsequent play and randomly reselects the predetermined game position of each additional special symbol previously displayed in a preceding play. This introduces some randomness into the appearance of the special symbols on the array for each successive play or spin of the feature game without reducing the number of special symbols displayed or the incremental increase of special symbols in each successive play.

In another preferred embodiment of the invention, the display 7 shows multiple arrays 10 that either form part of the same game or are separate games played independently. In either case, the appearance of a special symbol 25a in one of the cells 12 or on the display 7 causes the electronic game controller 4 to add special symbols 25 to the array 10 in which the first special symbol 25a appeared for the next play of the game. Alternatively, additional special symbols 25 are added each array for their respective next plays.

In another preferred form, the individual cells 12 each represent a single “reel” so that the 5×3 array 10 in FIGS. 3 to 7 has 15 separate reels instead of 5 reels. In this case, the invention would function in the same way, with the electronic game controller 4 selecting reels instead of cells 12 for displaying additional special symbols 25 once the first special symbol 25 appears in one of the reels.

In a further preferred form, the electronic game controller 4 determines winning combinations of the game symbols 9 at the conclusion of the spin of the reels 11 before determining whether the goose head symbol 25 has appeared on the array 10, In this embodiment, the player is given a second chance in each spin to obtain winning combinations of game symbols for a single spin of the reels 11. This embodiment adds to the player's excitement and thus retains his or her interest in playing the game on the electronic gaming machine 1.

While the embodiments in FIGS. 3 to 7 have been described in relation to the appearance of a single special symbol 25 in a play of the game, it will be appreciated that more than one special symbol can appear on the array 10. In this case, an additional special symbol 25 is displayed for each special symbol initially displayed in a play of the game, thus accelerating the increase of special symbols on the array. This embodiment may be used where the number of spins or plays in the game is less than the number of cells 12, so as to increase the chances of the special symbol 25 occupying each cell 12 of the array 10. This can also be extended to the subsequent plays of the game. That is, more than one additional special symbol 25 can be displayed in each subsequent play of the game. Generally, it is preferred that the number of plays in the game equals the number of cells 12 in the array 10 to avoid the added complexity involved with this embodiment.

Also, while the subsequent plays of the game 8 have been described as being successive or consecutive plays, it will be appreciated that the subsequent plays need not follow one after another, but can be separated from each other or occur in bunches or groups to add an element of randomness into the game. This may be useful where there are more subsequent plays than cells 12 in the array 10. In any event, the number of special symbols would never decrease between consecutive plays so that there is no reduction or loss of special symbols once acquired by the player.

Aside from applying the invention to a feature game only, as described in the preferred embodiment, it will be appreciated that the invention may be applied to a base game or a combination of a base game and a feature game offered on the electronic gaming machine. In the case of a base game only, the invention would work in substantially the same manner as described above. However, the player may be required to make a bet for each successive play. In the case of applying the invention both the base game and a feature game, the special symbol 25 would appear in a play or spin of the base game and the additional special symbols would appear in the feature game, with the first special symbol appearing in the base game being transferred over to the feature game.

The feature game may employ the same array as the base game, as well as the same game symbols 9 that are used in the base game. However, it will be appreciated that the array for the feature game may vary from the base game. For example, the feature game could adopt a different format of cells and/or use an entirely different set of game symbols, or a mixture of game symbols from the base game and different game symbols.

The video display screen 7 may also include a top screen, either as a separate display or integrated into the display screen 7, which provides jackpot information in the form of a major jackpot information box and a minor jackpot information box. The top screen ensures that the jackpot information is available to the player at all times during play of the electronic gaming machine 1.

In other preferred forms, the game has other features like jackpot prizes. The jackpot prize can be shared with any other games offered on the electronic gaming machine (as in multi-game gaming machines) or games offered on separate electronic gaming machines. Information relating to the jackpot prize(s) can be provided on the screen 7 or via a top screen that is devoted to displaying jackpot information. In one preferred form, the jackpot prize comprises a mystery jackpot. That is, none of the symbols in the game trigger the jackpot; hence the triggering event is a “mystery”. By way of comparison, a standard jackpot is typically symbol driven in that a particular combination of symbols must occur in the game to trigger the standard jackpot.

Also, in a further preferred form, the player can selectively stop spinning of the reels 11 to increase player interaction. Furthermore, the player can start spinning of the reels 11 to further enhance player interaction.

In the preferred embodiments, the video display screen 7 is a touch screen for use in addition to the player-actuatable buttons 6. This enables the player to select various features, such as responding to any messages or requests issued on the electronic gaming machine 1 by the electronic game controller 4. In this case, the player may control when the reels 11 start spinning and stop spinning in any of the games 8 by simply touching the relevant reel 11.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices) and other electronic devices capable of displaying a game. In each of these types of electronic gaming machines, there is a visual display with an electronic game controller in the form of a processor or central processing unit. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a computer system configured comprising a central processing unit configured for communication with an electronic gaming machine to perform the invention. In a yet another aspect, the invention includes a non-transitory carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the random selection of cells 12 for displaying the special symbols 25 for each successive or subsequent play can be combined with the provision of multiple arrays 10 in the feature game 8.

By providing special symbols that gradually increase in number for subsequent plays of the game and that increase the chance of obtaining winning combinations of game symbols, the invention increases the player's excitement and heightens his or her anticipation of a higher prize for each subsequent play. This retains player interest and encourages the player to continue playing the same electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine comprising:
a display for displaying a game, wherein said game comprises game symbols displayed in predetermined game positions on said display and where predetermined winning combinations of randomly selected game symbols in said game award prizes to a player, said game symbols including one or more special symbols;
vending slots for receiving monetary bets; and
an electronic game controller being configured to determine if a bet has been received using the vending slots to initiate play of said game and to control the display of said game symbols on the display if the bet has been received,
wherein the appearance of at least one special symbol in a play of said game causes said electronic game controller to display an additional special symbol in addition to said at least one special symbol on said display for one or more subsequent plays of said game.
